(19) United States
(12) Patent Application Publication
(10) Pub. No.: US 2010/0094988 A1
(43) Pub. Date: Apr. 15, 2010

(54) AUTOMATIC DISCOVERY FRAMEWORK FOR INTEGRATED MONITORING OF DATABASE PERFORMANCE

(75) Inventors: David W. Chang, San Jose, CA (US); Holger Karn, Aidlingen (DE); Bilung Lee, San Jose, CA (US); Paul Arnold Ostler, Yakima, WA (US)

Correspondence Address: KONRAD RAYNES & VICTOR, LLP;ATTN: IBM54, 315 SOUTH BEVERLY DRIVE, SUITE 210, BEVERLY HILLS, CA, 90212, US

(73) Assignee: INTERNATIONAL BUSINESS MACHINES CORPORATION, Armonk, NY (US)

(21) Appl. No.: 12/248,753

(22) Filed: Oct. 9, 2008

(51) Int. Cl. G06F 15/173

(52) U.S. Cl. 709/224

(57) ABSTRACT

Provided are techniques for monitoring information. In response to a database process starting, a monitoring agent is loaded under control of the database process, wherein the monitoring agent invokes a discovery service to discover a central server and monitoring service. Under control of the monitoring agent, monitor information about the database process is sent to the central server and monitoring service.

### BACKGROUND

1. Field

Embodiments of the invention relate to an automatic discovery framework for integrated monitoring of database performance.

2. Description of the Related Art

Database monitoring is often required for performance analysis and problem determination in a modern complex database environment. One existing approach today is to provide an interface wrapper around client applications to gather statistics for monitoring. The interface wrapper intercepts the database access via client interfaces. Thus, the information is limited to the client side only and is unable to provide detailed statistics.

Another existing approach is to have a network listener to intercept the database access to collect monitoring data. The network listener gathers information only from network traffic and cannot provide details on either the server or the client statistics. As a result, this approach does not provide complete end-to-end monitoring and will not work if the network flow is encrypted.

Moreover, typical monitoring solutions existing today are not well-suited for deployment in a distributed enterprise environment because they often require separate installation (on the clients and servers) and manual configuration (on the clients and servers).

Thus, there is a need in the art for an automatic discovery framework for integrated monitoring of database performance.

### BRIEF SUMMARY

Provided are a method, computer program product, and system for monitoring information. In response to a database process starting, a monitoring agent is loaded under control of the database process, wherein the monitoring agent invokes a discovery service to discover a central server and monitoring service. Under control of the monitoring agent, monitor information about the database process is sent to the central server and monitoring service.

### BRIEF DESCRIPTION OF THE SEVERAL VIEWS OF THE DRAWINGS

Referring now to the drawings in which like reference numbers represent corresponding parts throughout:

FIG. 1 illustrates a self-discovery framework that enables integrated monitoring of end-to-end database performance in accordance with certain embodiments.

FIG. 2 illustrates logic for monitoring of end-to-end database performance in accordance with certain embodiments. FIG. 2 is formed by FIGS. 2A and 2B.

FIG. 3 illustrates logic performed by the discovery service in accordance with certain embodiments.

FIG. 4 illustrates a system architecture that may be used in accordance with certain embodiments.

### DETAILED DESCRIPTION

In the following description, reference is made to the accompanying drawings which form a part hereof and which illustrate several embodiments of the invention. It is understood that other embodiments may be utilized and structural and operational changes may be made without departing from the scope of the invention.

Embodiments provide a framework for end-to-end database performance monitoring. Embodiments capture monitoring statistics in a distributed enterprise environment. Database processes on either the server side or the client side or both are seamlessly integrated within this framework to facilitate performance analysis based on monitoring statistics. Embodiments provide a tight integration between database processes and the framework to ensure minimal performance overhead and relevant (e.g., key) information collection for database monitoring. The framework also provides mechanisms for automatic or manual component discovery (e.g., key component discovery). These multiple mechanisms provide flexibility among various network environments. In addition, the automatic mechanisms eliminate burdensome setup and cumbersome configuration.

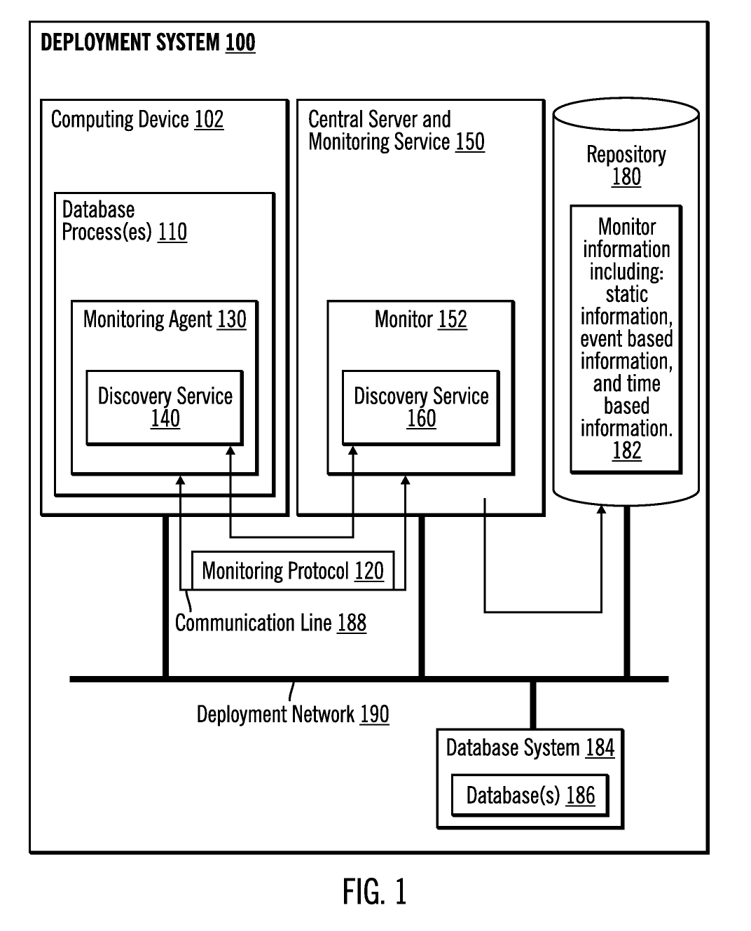

FIG. 1 illustrates a deployment system 100 having a self-discovery framework that enables integrated monitoring of end-to-end database performance in accordance with certain embodiments. In the deployment system 100, a computing device 102, a central server and monitoring service 150, and a repository 180 are coupled by a communication path 190. The computing device 102 may be a client or a server. Although one instance of computing device 102 are illustrated, there may be many instances of the computing device 102 coupled to the communication path. The central server and monitoring service 150 may be any host (e.g., any computing device (even computing device 102) client or server) in the deployment network (i.e., the distributed enterprise environment). In certain embodiments, there are multiple instances of the central server and monitoring service 150 that can be discovered by the computing devices 102.

The computing device 102 includes one or more database processes 110. A database process 110 may be described as any sort of client application interacting with a database. The database process 110 includes a monitoring agent 130. The monitoring agent 130 includes a discovery service 140.

The central server and monitoring service 150 includes a monitor 152. The monitor 152 includes a discovery service 160.

A monitoring protocol 120 may be described as being on a communication line 188 (e.g., a “wire”) connecting the monitoring agent 130 and monitor 152. In certain embodiments, communication line 188 is part of the deployment network 190. The monitoring protocol 120 defines commands and data involved in collecting monitoring statistics. The monitoring protocol 120 is part of the framework. The monitoring protocol 120 may be versioned and may be enhanced in the future while also supporting down-level versions.

In certain embodiments, the monitoring agent 130 is integrated into software supporting monitoring. In other embodiments, the monitoring agent 130 may take the form of hardware or firmware or some combination of software, hardware, and firmware. The monitoring agent 130 is initialized on load of the database process 110. The monitoring agent 130 runs on the database process 110 (where the database process can be a server or a client process) and uses the monitoring protocol 120 and the discovery service 140 to establish a connection and communicate monitoring statistics with the central server and monitoring service 150.

The discovery services 140, 160 provide a mechanism for discovering the central server and monitoring service 150. The discovery service 140, 160 has two parts: one for an instance of the computing device 102 and one for the central server and monitoring service 150. Discovery service 140 implements heuristics for discovering the central server and monitoring service 150 with no configuration or minimal configuration (e.g., configuration by a system administrator that is transparent to the database process 110).

The central server and monitoring service 150 provides a central location for monitoring agents 130 (i.e., one at each instance of computing device 102) to connect to and to communicate monitor information 182. The central server and monitoring service 150 collects data from instances of the computing device 102 and stores the data in the repository 180. For example, repository 180 includes monitor information 182 including: static information, event based information, and time based information. In certain embodiments, the central server and monitoring service 150 may be described as a process that runs on any host in the deployment network.

The repository 180 is used for storing information relevant to the deployment system 100 such as the monitored statistics collected. The repository 180 serves as a data store that can be queried and analyzed by tools specialized in consuming this information. In certain embodiments the repository 180 is part of a Relational Database Management System (RDBMS). In certain embodiments, the repository 180 may comprise an array of storage devices, such as Direct Access Storage Devices (DASDs), Just a Bunch of Disks (JBOD), Redundant Array of Independent Disks (RAID), virtualization device, etc.

The communication path 190 may comprise any type of communication path, such as, for example, a peer-to-peer network, spoke and hub network, Storage Area Network (SAN), a Local Area Network (LAN), Wide Area Network (WAN), the Internet, an Intranet, etc.

A database system 184 (coupled to the deployment network 190) may include one or more databases 186, and the database processes 110 may communicate with the databases 186.

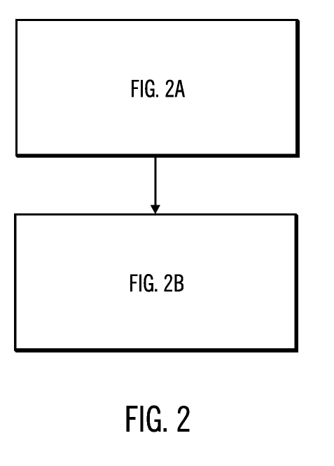

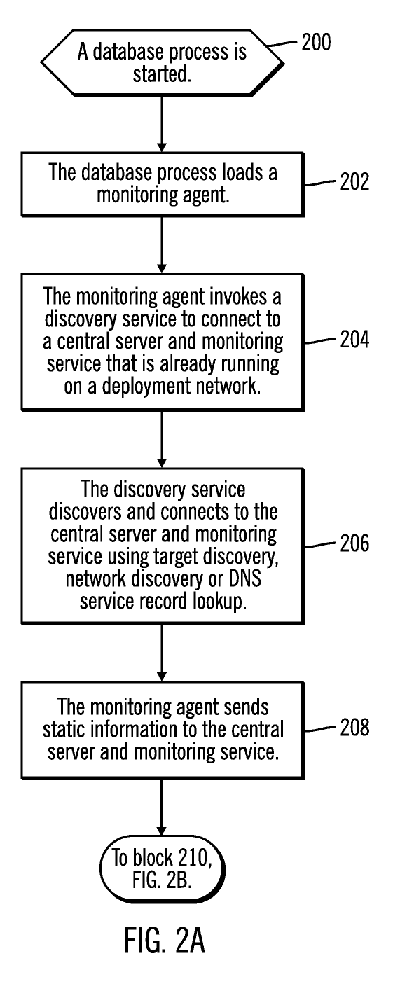

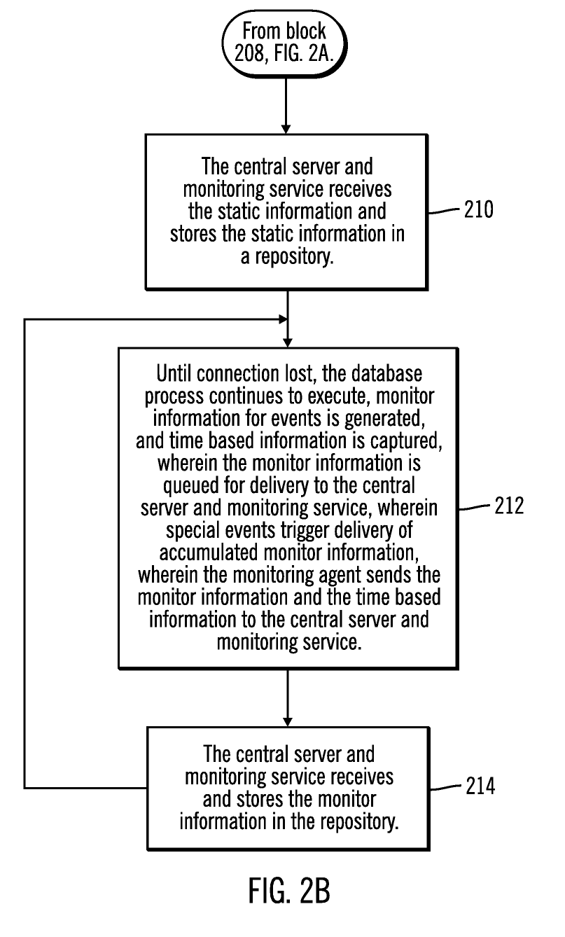

FIG. 2 illustrates logic for monitoring of end-to-end database performance in accordance with certain embodiments. FIG. 2 is formed by FIGS. 2A and 2B. The processing of FIG. 2 occurs when the central server and monitoring service 150 and the repository 180 are running on the deployment network. In block 200, a database process 110 (either on a client or a server) is started. In block 202, the database process 110 loads the monitoring agent 130. In block 204, the monitoring agent invokes the discovery service 140 to connect to the central server and monitoring service 150.

In block 206, the discovery service 140 discovers and connects to the central server and monitoring service 150 using targeted discovery, network discovery, or Domain Name System (DNS) service record lookup. In block 208, the monitoring agent 130 sends static information to the central server and monitoring service 150. From block 208 (FIG. 2A), processing continues to block 210 (FIG. 2B).

In block 210, the central server and monitoring service 150 receives the static information and stores the static information in the repository 180. In block 212, until the connection to the central server and monitoring service 150 is lost, the database process 110 continues to execute, event based information for events is generated, and time based information is captured at regular intervals. The event based information is stored (e.g., queued) for delivery to the central server and monitoring service. Special events may trigger delivery of accumulated event based information, and, when a special event occurs, the accumulated event based information is sent through the monitoring agent 130 to the central server and monitoring service. The monitoring agent 130 sends the event based information (when an event occurs) and the time based information (at regular intervals) to the central server and monitoring service 150.

In block 214, the central server and monitoring service 150 receives the event based information and the time based information and stores the event based information and the time based information in the repository 180. Monitor information 182 includes the time based information and the event based information. From block 214, processing loops back to block 212. The loop ends when the connection between the monitoring agent 130 and the central server and monitoring service 150 is broken or when either the monitoring agent 130 or the central server and monitoring service 150 stops processing.

At any time, new database processes at new instances of computing device 102 may be started in the deployment network. Also, the monitoring agent 130 is capable of sending static information, event based information, and time based information directly (i.e., without use of the discovery service 140) to the central server and monitoring service 150.

The discovery service 140 provides a mechanism for the monitoring agent 130 to locate the central server and monitoring service 150. Due to a wide range of possible deployment environments/configurations, the discovery service 140 is flexible enough to accommodate different deployment environments/configurations. To accomplish this, the discovery service 140 is capable of using at least three techniques for locating the central server and monitoring service 150:

1. Network Discovery

2. Domain Name System (DNS) Service Records

3. Targeted Discovery

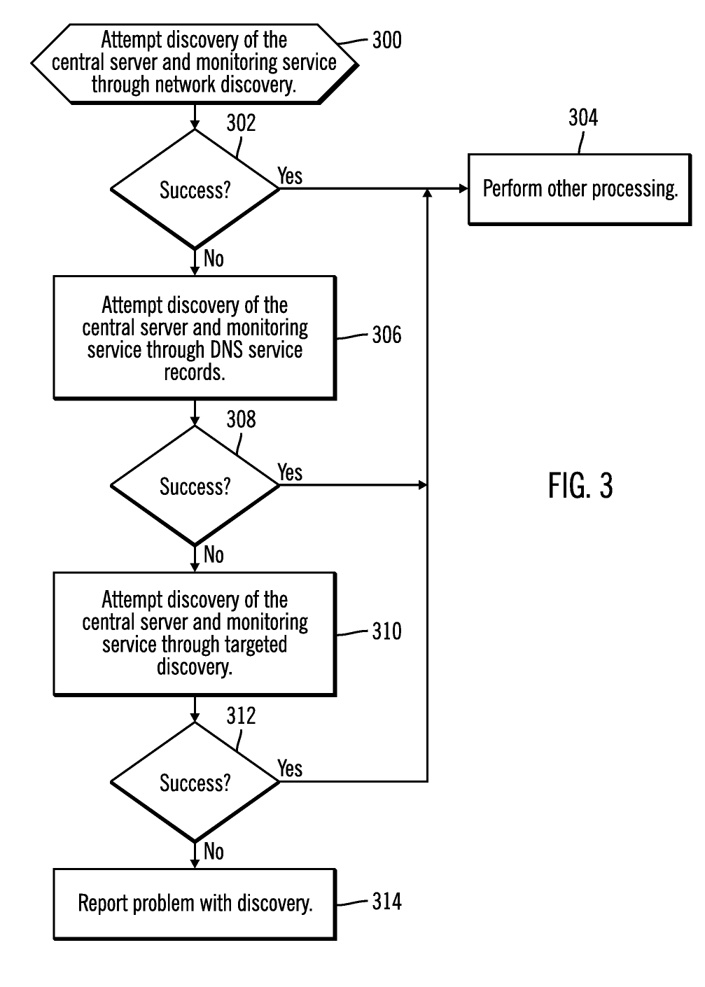

FIG. 3 illustrates logic performed by the discovery service 140 in accordance with certain embodiments. Control begins at block 300 with the discovery service 140 attempting discovery of the central server and monitoring service 150 through network discovery.

Network discovery may provide a zero configuration technique for locating the central server and monitoring service 150. This technique discovers the central server and monitoring service 150 through Internet Protocol (IP) multicast (i.e., the delivery of information to a group of interested receivers) or broadcast (i.e., the delivery of information to all nodes (e.g., devices) on the deployment network 190). Discovery through network discovery works as follows:

1. The discovery service 160 on the central server and monitoring service 150 is initialized on a host connected to the deployment network and joins an IP multicast group to which the discovery service 160 listens for lookup requests.

2. A database process 110 (also referred to as a monitored process) is started on the deployment network and invokes the discovery service 140.

3. The discovery service 140 queries for an available central server and monitoring service 150 using multicast or broadcast.

4. The discovery service 160 on the central server and monitoring service 150 responds with information necessary to connect (e.g., IP address/port).

5. The discovery service 140 uses the returned information to open a connection to the central server and monitoring service 150.

Network discovery is useful when a database and database applications run on a same subnetwork (i.e., a portion of the computers and devices on the deployment network that have a common, designated IP address routing prefix. When deployments are across subnets, routers or proxies may need to be setup or configured.

In block 302, the discovery service 140 determines whether the discovery was successful. If so, processing continues to block 304, otherwise, processing continues to block 306. In block 304, other processing occurs (e.g., collecting monitor information 182 and sending the monitor information 182 to the central server and monitoring service 150, where the monitor information 182 capture/reporting occurs as the database process 110 is executing).

In block 306, the discovery service 140 attempts to discovery of the central server and monitoring service 150 through DNS service records. Discovery through DNS service records provides another technique for discovering the central server and monitoring service 150 and does not depend on subnet layout. This technique is useful if a deployment is across subnets (i.e., subnetworks) within a single domain. A domain may be described as a collection of network devices that are organized under a common network name (i.e., domain name) in the Internet Domain Name System (DNS). If the DNS server for the deployment network supports updating of service records, then this technique is also a zero-configuration solution. If not, this technique requires minimal configuration involving adding DNS-Service (SRV) records for the monitoring application into the DNS servers for the deployment domain. A service record may be described as a category of data in the Internet Domain Name System specifying information on available services. Discovery through DNS service records works as follows:

1. The central server and monitoring service 150 is started on a host domain (e.g., server1.dev.foobar.com).

2. The discovery service 160 on the central server and monitoring service 150 creates/updates the DNS service record for the central server and monitoring service 150 that points to the IP address/port of the central server and monitoring service 150 for a domain (e.g., dev.foobar.com).

3. A database process 110 with a monitoring agent 130 is started on a host (e.g., host1.dev.foobar.com) and invokes the discovery service 140.

4. The discovery service 140 performs a DNS service record lookup for the central server and monitoring service 150 record on a domain (e.g., dev.foobar.com).

5. The DNS server responds with the lookup information necessary to connect (e.g., IP address/port)

6. The discovery service 140 uses the returned information to open a connection to the central server and monitoring service 150.

In block 308, the discovery service 140 determines whether the discovery was successful. If so, processing continues to block 304, otherwise, processing continues to block 310. In block 304, the discover service attempts to discover the central server and monitoring service 150 through targeted discovery. This technique of discovery involves configuring either a system or process variable to point to a host that provides lookup information. Discovery through targeted discovery works as follows:

1. A lookup server is started. This can be the discovery service 160 on the central server and monitoring service 150 or a standalone lookup server (not shown in FIG. 1).

2. A computing device 102 (also referred to as an application host in some embodiments) has a special system or process variable configured to point to the lookup server.

3. A database process 110 is started and the discovery service 140 is invoked. The discovery service 140 makes a request to the lookup server designated in the system/process variable. This request can be as simple as HTTP/GET.

4. The lookup server responds with lookup information necessary to connect (e.g., IP address/port).

5. The discovery service 140 uses the returned information to open a connection to the central server and monitoring service 150.

The monitoring protocol 120 defines the command and object data involved in monitoring. The monitoring protocol 120 takes two considerations into account.

1. What information to capture.

2. How to deliver the information.

The first consideration is what information to capture. There is a wide range of valuable information to collect for monitored database processes running in the deployment system 100. Some different types of information may be categorized into 3 groups:

1. Static information

2. Event based information

3. Time based information

Static information may include details such as the information about the host operating system, physical memory, process identifier (ID), versions, runtime properties, etc. Static information does not change as the monitored database processes execute.

Event based information captures state information specific to when particular events occur in the deployment system 100. A database system 184 (coupled to the deployment network 190) may include one or more databases 186, and the database process 110 may communicate with the databases 186. In the database system 184, events may include opening/closing of connections, start/end of transactions, statement executions, exceptions, etc. Each event may contain different detail information. For example event information for statement executions may include start timestamp, driver time, network time, server time, and number of round trips, etc. Events can even be triggered when particular statistics exceed a defined threshold. For instance, there can be a threshold for the number of open statements, and an event is generated when that threshold is exceeded.

Time based information consists of a wide range of statistics that fluctuate over time. These statistics can be collected at regular intervals. Time based information statistics can include: available memory, used memory, Central Processing Unit (CPU) consumption, number of connections, peak number of connections, connection pool wait time, etc.

In terms of defining how to deliver the information, delivery defines how to send the information and when to send the information. The information collected may be serialized into object data for transport over the wire. The object data format may be either binary or string based (Extensible Markup Language (XML), JavaScript® Object Notation (JSON), etc.) (Javascript Solaris is a registered trademark or common law mark of Sun Microsystems in the United States and/or other countries). Efficiently sending monitor information 182 helps ensure minimal performance impact to the process being monitored. The monitor information 182 may be sent as the information is collected or may be accumulated (i.e., bundled) with other information. The monitor information 182 transmission may be defined such that the monitor information 182 may be bundled and transported when specific events occur, such as the end of a unit of work. This way the transmission minimizes impact to the current unit of work.

Thus, the monitoring agent 130 is included in monitoring enabled database clients and servers. The monitoring agent 130 is responsible for communicating with the central server on behalf of the monitored database processes. There is typically one monitoring agent 130 per process to be monitored. The monitoring agent 130 is initialized on load of the database process 110 and invokes the discovery service 140 to establish a connection with the central server and monitoring agent 150.

The central server and monitoring service 150 may be described as a deployment wide server responsible for communicating with monitoring agents on instances of computing device 102 and handling the received information. Monitoring agents connected to the central server and monitoring service 150 send monitor information 182 through the monitor application protocol 120. The central server and monitoring service 150 extracts the monitor information 182 sent over the communication line 188 and stores the information in the repository 150.

The repository 180 serves as a data store for information collected by the central server and monitoring service 150 from monitoring agents on instances of the computing device 102. The repository 180 may be a persistent store for collected information and makes the information available for analysis tools.

### ADDITIONAL EMBODIMENT DETAILS

As will be appreciated by one skilled in the art, embodiments may be implemented as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system”. Furthermore, embodiments may take the form of a computer program product embodied in any tangible medium of expression having computer-useable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Current examples of optical disks include compact disk-read only memory (CD-ROM), compact disk-read/write (CD-R/W) and DVD. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the embodiments may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The code implementing the described operations may further be implemented in hardware logic (e.g., an integrated circuit chip, Programmable Gate Array (PGA), Application Specific Integrated Circuit (ASIC), etc.). Still further, the code implementing the described operations may comprise a receiver or transmitter device or other physical carrier capable of processing or implementing the code as “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a computer readable medium at the receiving and transmitting stations or devices.

The embodiments are described herein with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Certain implementations may be directed to a method for deploying computing infrastructure by a person or automated processing integrating computer-readable code into a computing system, wherein the code in combination with the computing system is enabled to perform the operations of the described implementations.

The logic of FIGS. 2 and 3 describes specific operations occurring in a particular order. In alternative embodiments, certain of the logic operations may be performed in a different order, modified or removed. Moreover, operations may be added to the above described logic and still conform to the described embodiments. Further, operations described herein may occur sequentially or certain operations may be processed in parallel, or operations described as performed by a single process may be performed by distributed processes.

The illustrated logic of FIGS. 2 and 3 may be implemented in software, hardware, programmable and non-programmable gate array logic or in some combination of hardware, software, or gate array logic.

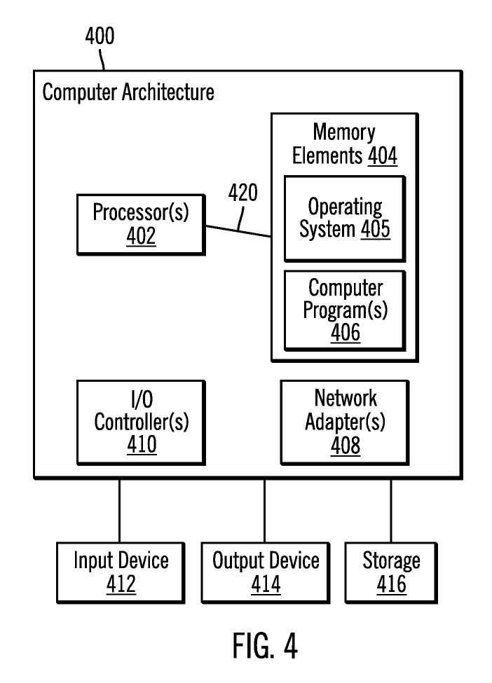

FIG. 4 illustrates a system architecture 400 that may be used in accordance with certain embodiments. Computing device 102 and/or central server and monitoring service 150 may implement system architecture 400. The system architecture 400 is suitable for storing and/or executing program code and includes at least one processor 402 coupled directly or indirectly to memory elements 404 through a system bus 420. The memory elements 404 may include local memory employed during actual execution of the program code, bulk storage, and cache memories which provide temporary storage of at least some program code in order to reduce the number of times code must be retrieved from bulk storage during execution. The memory elements 404 include an operating system 405 and one or more computer programs 406.

Input/Output (I/O) devices 412, 414 (including but not limited to keyboards, displays, pointing devices, etc.) may be coupled to the system either directly or through intervening I/O controllers 410.

Network adapters 408 may also be coupled to the system to enable the data processing system to become coupled to other data processing systems or remote printers or storage devices through intervening private or public networks. Modems, cable modem and Ethernet cards are just a few of the currently available types of network adapters 408.

The system architecture 400 may be coupled to storage 416 (e.g., a non-volatile storage area, such as magnetic disk drives, optical disk drives, a tape drive, etc.). The storage 416 may comprise an internal storage device or an attached or network accessible storage. Computer programs 406 in storage 416 may be loaded into the memory elements 404 and executed by a processor 402 in a manner known in the art.

The system architecture 400 may include fewer components than illustrated, additional components not illustrated herein, or some combination of the components illustrated and additional components. The system architecture 400 may comprise any computing device known in the art, such as a mainframe, server, personal computer, workstation, laptop, handheld computer, telephony device, network appliance, virtualization device, storage controller, etc.

The foregoing description of embodiments of the invention has been presented for the purposes of illustration and description. It is not intended to be exhaustive or to limit the embodiments to the precise form disclosed. Many modifications and variations are possible in light of the above teaching. It is intended that the scope of the embodiments be limited not by this detailed description, but rather by the claims appended hereto. The above specification, examples and data provide a complete description of the manufacture and use of the composition of the embodiments. Since many embodiments may be made without departing from the spirit and scope of the embodiments, the embodiments reside in the claims hereinafter appended or any subsequently-filed claims, and their equivalents.

1. A computer-implemented method, comprising:
in response to a database process starting, loading a monitoring agent under control of the database process, wherein the monitoring agent invokes a discovery service to discover a central server and monitoring service; and
under control of the monitoring agent, sending monitor information about the database process to the central server and monitoring service.

2. The method of claim 1, further comprising:
under control of the discovery service,
discovering the central server and monitoring service using one of: network discovery, Domain Name System (DNS) service records, and targeted discovery; and
connecting to the central server and monitoring service.

3. The method of claim 1, wherein the monitor information is static information.

4. The method of claim 1, wherein the monitor information is event based information that is accumulated and stored for transmission to the central server and monitoring service in response to an event being triggered.

5. The method of claim 1, wherein the monitor information is time based information captured at regular intervals.

6. The method of claim 1, wherein the discovery service is a first discovery service that communicates with a second discovery service at the central server and monitoring service.

7. The method of claim 1, further comprising:
under control of the central server and monitoring service,
receiving the monitor information; and
storing the monitor information in a repository.

8. A system, comprising:
logic capable of performing operations, the operations comprising:
in response to a database process starting, loading a monitoring agent under control of the database process, wherein the monitoring agent invokes a discovery service to discover a central server and monitoring service; and
under control of the monitoring agent, sending monitor information about the database process to the central server and monitoring service.

9. The system of claim 8, wherein the operations further comprise:
under control of the discovery service,
discovering the central server and monitoring service using one of: network discovery, Domain Name System (DNS) service records, and targeted discovery; and
connecting to the central server and monitoring service.

10. The system of claim 8, wherein the monitor information is static information.

11. The system of claim 8, wherein the monitor information is event based information that is accumulated and stored for transmission to the central server and monitoring service in response to an event being triggered.

12. The system of claim 8, wherein the monitor information is time based information captured at regular intervals.

13. The system of claim 8, wherein the discovery service is a first discovery service that communicates with a second discovery service at the central server and monitoring service.

14. The system of claim 8, wherein the operations further comprise:
under control of the central server and monitoring service,
receiving the monitor information; and
storing the monitor information in a repository.

15. A computer program product comprising a computer useable medium including a computer readable program, wherein the computer readable program when executed on a computer causes the computer to:
in response to a database process starting, load a monitoring agent under control of the database process, wherein the monitoring agent invokes a discovery service to discover a central server and monitoring service; and
under control of the monitoring agent, send monitor information about the database process to the central server and monitoring service.

16. The computer program product of claim 15, wherein the computer readable program when executed on a computer causes the computer to:
under control of the discovery service,
discover the central server and monitoring service using one of: network discovery, Domain Name System (DNS) service records, and targeted discovery; and
connect to the central server and monitoring service.

17. The computer program product of claim 15, wherein the monitor information is static information.

18. The computer program product of claim 15, wherein the monitor information is event based information that is accumulated and stored for transmission to the central server and monitoring service in response to an event being triggered.

19. The computer program product of claim 15, wherein the monitor information is time based information captured at regular intervals.

20. The computer program product of claim 15, wherein the discovery service is a first discovery service that communicates with a second discovery service at the central server and monitoring service.

21. The computer program product of claim 15, wherein the computer readable program when executed on a computer causes the computer to:
under control of the central server and monitoring service,
receive the monitor information; and
store the monitor information in a repository.
